(19) United States
(12) Patent Application Publication
(10) Pub. No.: US 2010/0000208 A1
(43) Pub. Date: Jan. 7, 2010

(54) HYDRAULIC FLUID AND METHOD

(75) Inventors: Thomas John McKechnie, Leigh (GB); Dean Anthony Askew, Leigh (GB)

Correspondence Address: ADAMS INTELLECTUAL PROPERTY LAW, Suite 2350 Charlotte Plaza, 201 South College Street, CHARLOTTE, NC, 28244, US

(73) Assignee: NICHE PRODUCTS LIMITED, Leigh (GB)

(21) Appl. No.: 12/301,124

(22) PCT Filed: Apr. 23, 2007
(86) PCT No.: PCT/GB2007/001465

§ 371 Date: Apr. 17, 2009

(30) Foreign Application Priority Data
May 22, 2006 (GB) 0610081.2
Apr. 23, 2007 (GB) PCT/GB2007/001465

(51) Int. Cl. F16D 31/00; C10M 137/02

(52) U.S. Cl. 60/327; 508/430; 508/426; 508/428

(57) ABSTRACT

There are provided hydraulic fluids comprising at least one phospholipid lubricant blended with one or more of a glycol, glycerol or a glycerol ester and having a water content of less than 10% by weight. Also provided are hydraulic systems and methods of using and manufacturing hydraulic fluids.

### FIELD OF THE INVENTION

The present invention relates to hydraulic fluids, particularly, though not exclusively, to hydraulic fluids for use in the offshore oil and gas industry and to methods of their use and preparation and to systems incorporating them.

### BACKGROUND TO THE INVENTION

There are many known hydraulic fluids for use in hydraulic systems having mechanical components driven by pressurised hydraulic fluid.

The specific requirements upon these fluids vary depending on the application but typically include a need for adequate fluid stability, lubricity, anti-wear, corrosion protection, bacterial protection and viscosity.

It is also becoming increasingly important that the fluids have minimal environmental impact on disposal or release from a hydraulic system. This applies in particular to offshore oil and gas drilling and production activities where released oil has the potential to enter the marine environment, but is also important for other more general onshore and offshore hydraulic systems.

Many hydraulic fluid system applications use standard ISO hydraulic oils with varying viscosity dependent on application.

A number of disadvantages, particularly environmental disadvantages, associated with many known hydraulic fluids, particularly ISO type hydraulic oils, are attributable to their use of oil, especially mineral oil or synthetic hydrocarbon oil.

As alternatives to such oil based products, it would be advantageous to provide hydraulic fluids, particularly ISO oil equivalent fluids, which do not include large quantities, or indeed any quantity of oil, especially mineral oil or synthetic hydrocarbon oil, which oils create environmental problems especially in offshore applications.

It would furthermore be advantageous to provide hydraulic fluids, particularly ISO oil equivalent fluids, which include environmentally friendly lubricants, which lubricants do not rely on mineral or synthetic hydrocarbon oil formulations in order to work effectively.

It is therefore an aim of preferred embodiments of the present invention to overcome or mitigate at least one problem of the prior art, whether expressly disclosed herein or not.

### SUMMARY OF THE INVENTION

According to a first aspect of the present invention there is provided a hydraulic fluid comprising at least one phospholipid lubricant blended with one or more of a glycol, glycerol or a glycerol ester and having a water content of less than 10% by weight.

As used herein, the term “hydraulic fluid” means a fluid which is suitable to be used to operate hydraulic machinery and/or equipment.

Preferably, a fluid suitable to be used to operate hydraulic machinery and/or equipment meets a number of criteria. Suitably, these include the fluid having suitable fluid stability, lubricity and viscosity. These may suitably include the fluid having suitable fluid stability, lubricity, anti-wear, corrosion protection, bacterial protection and viscosity.

Suitably, the hydraulic fluid comprises a stable fluid. Suitably, the hydraulic fluid has sufficient stability to ensure the fluid does not separate in service.

Suitably, the fluid has sufficient stability that if left to stand at ambient temperature it substantially does not separate to form separate fluid layers until at least a minimum time, for example 3 months, has elapsed from manufacture.

Suitably, the fluid has sufficient stability that if left to stand at ambient temperature it substantially does not precipitate to form solid precipitate until at least a minimum time, for example 3 months, has elapsed from manufacture.

Suitably, the fluid has sufficient stability that if left to stand at ambient temperature it substantially does not become increasingly hazy due to separation and/or precipitation until at least a minimum time, for example 3 months, has elapsed from manufacture.

Suitably, said minimum time may be at least 3 months from manufacture, preferably at least 6 months from manufacture and may be longer.

Suitably, the fluid has sufficient stability that if the fluid is left to stand, suitably at ambient temperature, for a minimum of 3 months from manufacture, suitably a minimum of 6 months, and then filtered in line with methods outlined in ISO 5507:2002 ‘Determination of particulate contamination by the counting method using an optical microscope’ or similar method, that it does not exceed a code 22/20/17 (NAS 1638 Class 11) using ISO 4406:1999 test method ‘Fluids—methods for coding the levels of contamination by solid particles’ or similar incorporated herein by reference.

Suitably, the stability of the fluid is achieved by a high pressure homogenisation process during manufacture. Suitably, the fluid is homogenised at pressures of at least 500PSI (35 Kilograms/cm²). The fluid may be homogenised at pressures of between 500PSI and 15,000PSI (35-1054 Kilograms/cm²), for example between 2,000 and 5,000 PSI (141-351 Kilograms/cm²).

Suitably, the hydraulic fluid has sufficient lubricity to allow moving surfaces (such as metal to metal contacts within valves), to slide without sticking or wearing outside of acceptable limits.

The lubricity of a fluid can be determined using several test methods including Falex lubricity test equipment.

The hydraulic fluid may, for example, suitably have a maximum torque value of 20 lb. In at 250 lb load and a maximum of 30 wear teeth under the Falex test protocol ASTM D2670-95 (Reaproved 2004) incorporated herein by reference.

Suitably, the lubricity and/or anti-wear parameters of the fluid are in line with those of a standard ISO hydraulic oil, for example those of Shell Tellus 32™ or Shell Tellus 46™.

The fluid may be suitable for use in place of a standard ISO hydraulic oil such as, for example, Shell Tellus 22™, Shell Tellus 32™, Shell Tellus 46™ and Shell Tellus 68™ (the last 2 numbers representing the viscosity of the fluid at 40° C.).

Suitably, the hydraulic fluid has an appropriate viscosity to allow it to be driven through a hydraulic system in service without causing system damage and/or cavitation.

Suitably, the hydraulic fluid has a viscosity of between 10 cSt and 200 cSt at 40° C. The viscosity may for example lie between 10 cSt and 200 cSt at 40° C. when determined using Institute of Petroleum IP71 Section 1/97 or ISO 3104:1996, Petroleum products—transparent and opaque liquids; determination of kinematic viscosity and calculation of dynamic viscosity incorporated herein by reference. Alternatively, other appropriate test methods may be used.

The viscosity may be tailored within this range for a given hydraulic system application and/or hydraulic fluid in use. The fluid may be tailored for use in the majority of hydraulic fluid applications requiring a viscosity between 10 cSt and 200 cSt which may currently run on ISO hydraulic oils. For example, the fluid may be tailored to run on equipment currently using ISO hydraulic oils. The fluid may be tailored to run on equipment currently using ISO hydraulic oils having viscosities of between 10 cSt and 200 cSt such as Shell Tellus 22™, Shell Tellus 32™, Shell Tellus 46™ and/or Shell Tellus 68™ (the last 2 numbers represent the viscosity of the fluid at 40° C.). The viscosity of the hydraulic fluid may for example 11e between 20 cSt and 50 cSt at 40° C.

As used herein, the term ISO hydraulic oils refers to oils having a viscosity between 10 cSt and 200 cSt at 40° C. which fall within the scope of ISO 3448:1992, ‘Industrial liquid lubricants—ISO viscosity classification’ as measured using ISO 3104:1996, ‘Petroleum products—transparent and opaque liquids; determination of kinematic viscosity and calculation of dynamic viscosity’ incorporated herein by reference. It should be noted that commercially branded ISO Hydraulic Fluids referred to in this application carry the designated ISO viscosity Grade at 40° C. as the last 2 numbers, for example Shell Tellus 32™ carries the ISO Viscosity Grade 32, or ISO VG 32 in its shortened nomenclature.

In some circumstances a fluid may need to have its viscosity modified to match a certain technical profile, this may involve adding additives to increase or decrease the viscosity of the product. Suitably, the hydraulic fluid has the required viscosity without the need for modification by additives.

Suitably, the hydraulic fluid has sufficient corrosion protection to protect metals in a hydraulic system from corrosion. This may be especially important if moderate seawater ingress is likely.

Suitably, the hydraulic fluid has sufficient biocidal protection to prevent excessive growth of fungus and bacteria within the hydraulic fluid medium.

Suitably, the hydraulic fluid does not adversely affect elastomers present within a hydraulic system.

Suitably, the hydraulic fluid has sufficient antifreeze protection to allow the fluid to be used in cold conditions.

Suitably, the hydraulic fluid is capable of operation at temperatures below −10° C.

Suitably, the hydraulic fluid is sufficiently environmentally acceptable to allow its discharge to the environment. Suitably, this may be the case under the individual regulations in place for each applicable country under whose legislation the fluid is used.

Suitably, the hydraulic fluid does not contain particulate matter that could block filters, cause excess wear and/or exceed equipment tolerances. Suitably, the fluid may comply with ISO 4406 code 22/20/17 (NAS 1638 Class 11) or better using ISO 4406:1999 test method ‘Fluids—methods for coding the levels of contamination by solid particles’ incorporated herein by reference. The fluid may better the criteria set by this ISO. The fluid may be filtered prior to use to achieve ISO 4406:1999 22/20/17 (NAS 1638 Class 11) or better although this level of cleanliness may not be necessary for all applications. Suitably, the fluid is filtered as part of the production process.

The fluid may be filtered using suitable industrial hydraulic filtration equipment capable of providing a fluid with code 22/20/17 (NAS 1638 Class 11) or better using ISO 4406:1999 test method ‘Fluids—methods for coding the levels of contamination by solid particles’ The fluid may be filtered through a 10 micron absolute filtration unit or better.

Suitably, the hydraulic fluid has a water content of less than 10% by weight, for example of no greater than: 9%; 8%; 7%; 6%; 5%; 4%; 3%; 2% or 1% by weight.

Preferably, the hydraulic fluid has a water content of 1% or less, suitably of 0.5% or less, for example of 0.1% or less. It may be preferred that the hydraulic fluid is substantially water-free. However, small quantities, for example up to around 10% by weight, of water may be included in the hydraulic fluid without significantly degrading the performance of the fluid.

Suitably, the hydraulic fluid comprises a blend of a phospholipid lubricant and one or more of a glycol, glycerol or a glycerol ester in which said blend forms at least 60% by weight of the fluid, more suitably at least 75%, preferably at least 85% by weight of the fluid.

Whilst it may be preferred that the blend of phospholipid lubricant and one or more of a glycol, glycerol or a glycerol ester constitute at least 85% by weight of the fluid, up to around 40% of a non-aqueous constituent could be added as a filler material to reduce the level of the blend required.

The hydraulic fluid may comprise a blend of a phospholipid lubricant and one or more of a glycol, glycerol or a glycerol ester in which said blend forms 85% by weight or greater, for example at least: 86%; 87%; 88%; 89%:90%; 91%; 92%; 93%; 94%; 95%; 96%; 97%; 98% or 99% by weight of the fluid.

It may be preferred that the hydraulic fluid consist essentially of blend of a phospholipid lubricant and one or more of a glycol, glycerol or a glycerol ester. The blend of phospholipid lubricant and one or more of a glycol, glycerol or a glycerol ester may comprise 95% by weight or more, for example 99% by weight or more, of the total weight of the hydraulic fluid. However, up to around 40% by weight in total, suitably up to around 25%, for example up to around 15% by weight in total of other substances may be included in the hydraulic fluid to modify the performance, for example the fluid behaviour, of the fluid and/or to reduce the level of the blend required.

Suitably, the hydraulic fluid is substantially free of a mineral oil, a synthetic hydrocarbon oil or any mixture thereof.

Suitably, the hydraulic fluid comprises the phospholipid as substantially the sole lubricant of the hydraulic fluid.

Suitably, the hydraulic fluid comprises at least 0.1% by weight of a phospholipid, for example at least 0.5% by weight.

Suitably, the hydraulic fluid comprises up to 50% by weight of a phospholipid, for example up to 30% by weight.

Suitably, from 0.1% to 50% by weight of the fluid may consist of a phospholipid, for example from 0.5% to 30% by weight.

Preferably the phospholipid lubricant comprises a phosphatide, especially having a structure

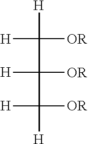

wherein at least one R is a phosphorus containing group having the structure

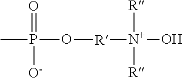

and at least one R is a fatty acyl group; and
wherein R′ is independently an alkyl group preferably independently having from 1 to 12 carbon atoms and R″ is an alkyl group preferably independently having from 1 to 8 carbon atoms, more preferably from 1 to 4 carbon atoms.

The fatty acyl group is preferably derived from a fatty acid having between 4 and 30 carbon atoms, such as octanoic acid, stearic acid, oleic acid, palmitic acid, behenic acid, myristic acid and oleosteric acid, for example.

Preferably one R group is a phosphorus containing group and two R groups are fatty acyl groups.

Preferred phosphatides are phosphatidylcholine, phosphatidylinositol, phosphatidylserine, and phosphatidyethanolamine.

There may be more than one phospholipid and preferably more than one phosphatide. For example the hydraulic fluid may comprise phosphatidylcholine, phosphatidylinositol and phosphatidylethanonamine.

The total concentration of the phospholipid lubricants preferably comprises at least 0.1% wt of the total weight of the hydraulic fluid, suitably at least 0.5% wt. The total concentration of the phospholipid lubricants may comprise at least 1% wt of the total weight of the hydraulic fluid, for example, at least 5% wt.

The phospholipids lubricant preferably comprises no more than 50% wt of the total weight of the hydraulic fluid, suitably no more than 40% wt. Suitably, the phospholipids lubricant comprises no more than 30% wt of the total weight of the hydraulic fluid, suitably no more than 25% wt, for example no more than 20% wt.

In preferred hydraulic fluids the total weight of the phospholipid lubricant comprises substantially 0.1-50% wt, suitably, 0.5-30% wt, for example 1-20% wt, of the total weight of the hydraulic fluid. The phospholipid lubricant may for example comprise substantially 0.9-3.1% wt of the total weight of the hydraulic fluid.

Especially preferred phospholipids are those derived from commercial fatty compounds such as soybean oil, cotton seed oil and castor seed oil.

A particularly preferred effective mixture of phosphatides and other phospholipids is found in soybean lecithin and other plant-derived lecithins. Plant-derived lecithins generally comprise a mixture of phosphatides, phospholipids and natural oils, in addition to other ingredients such as carbohydrates.

In preferred embodiments, the hydraulic fluid comprises a plant-derived lecithin, such as soybean lecithin, castor lecithin, rapeseed lecithin, cotton seed lecithin and the like, for example. Especially preferred is soybean lecithin, preferably comprising soybean oil, phosphatidylcholine, phosphatidylethanolamine, and phosphatidyinositol.

Suitably, the phospholipid lubricant comprises plant-derived lecithin.

Suitably, the hydraulic fluid comprises plant-derived lecithin as substantially the sole lubricant of the hydraulic fluid,

The plant-derived lecithin lubricant preferably comprises at least 0.1% wt of the total weight of the hydraulic fluid, suitably at least 0.5% wt. Suitably, the plant-derived lecithin lubricant comprises at least 1% wt of the total weight of the hydraulic fluid, for example, at least 5% wt.

The plant-derived lecithin lubricant preferably comprises no more than 50% wt of the total weight of the hydraulic fluid, suitably, no more than 40% wt.

In preferred hydraulic fluids the total weight of the plant derived lecithin lubricant comprises substantially 0.1-50% wt of the total weight of the hydraulic fluid, suitably 0.5-30% wt, for example 1-20% wt.

Suitably, the hydraulic fluid comprises a glycol, glycerol, a glycerol ester or combination thereof in an amount of at least 30% by weight, more suitably at least 40% by weight, suitably at least 50% by weight, for example at least 60% by weight. The hydraulic fluid may comprise a glycol, glycerol, a glycerol ester or combination thereof in an amount of at least 70% by weight, suitably at least 80% by weight, for example at least 90% by weight.

Suitably, the hydraulic fluid comprises a glycol, glycerol, a glycerol ester or combination thereof in an amount of up to 99.9% by weight, suitably up to 99% by weight, for example up to 90% by weight.

In preferred hydraulic fluids the total weight of a glycol, glycerol, a glycerol ester or combination thereof is substantially 30-99.9% wt of the total weight of the hydraulic fluid, suitably 50-99% wt.

The total weight of a glycol, for example monoethylene glycol, may be between 1% and 99%, suitably between 25% and 75% by weight of the hydraulic fluid, for example between 25% and 55%. The total weight of glycerol may be between 1% and 99%, suitably between 25% and 75% by weight of the hydraulic fluid, for example between 45% and 75%. In some embodiments a high concentration of the ingredients of the hydraulic fluid can provide sufficient antifreeze effect without the need for additional anti-freeze additives. Suitably, a glycol and/or a glycerol ester and/or glycerol may act as an anti-freeze component of the hydraulic fluid.

Suitable glycols include alkylene glycols, preferably having 1 to 12 carbon atoms in each alkylene group, which groups may be linear or branched. The alkylene glycols may be monoalkyleneglycols or dialkleneglycols. Preferred glycols include monoethyleneglycol and monopropyleneglycol, for example.

The hydraulic fluid may comprise only one of a glycol, glycerol or a glycerol ester. Suitably, the hydraulic fluid comprises a combination of two or more of a glycol, glycerol or a glycerol ester. Suitably, the hydraulic fluid comprises a combination of only two of a glycol, glycerol or a glycerol ester.

Suitably, the hydraulic fluid comprises a glycol. The glycol may comprise monoethylene glycol. The hydraulic fluid may comprise a glycol which consists of monoethylene glycol.

Suitably, the hydraulic fluid comprises glycerol.

The hydraulic fluid may comprise a combination of a glycol and glycerol, for example a monethylene glycol and glycerol combination.

The hydraulic fluid may comprise a glycerol ester.

Suitably, the hydraulic fluid comprises plant derived lecithin, monoethylene glycol and glycerol. Suitably, plant derived lecithin, monoethylene glycol and glycerol may comprise at least 90% by weight of the fluid, suitably at least 95% by weight, for example 99% by weight or 100% by weight.

Suitably, the hydraulic fluid may be arranged to be used in hydraulic machinery as supplied. The hydraulic fluid may thus not comprise a concentrate for forming a water-based hydraulic fluid.

The hydraulic fluid may comprise other additives such as corrosion inhibitors, anti-bacterial and anti-fungal additives, anti-freeze additives and stabilisers. Suitably the fluid comprises no more than 10% by weight in total of such additives, suitably no more than 5%, for example no more than 1% by weight.

The phospholipid lubricant and/or any additional lubricant present may also serve to function as a corrosion inhibitor. Alternatively or additionally the hydraulic fluid may comprise at least one separate corrosion inhibitor. The corrosion inhibitor may comprise an alkylamine or alkanolamine. Suitably alkylamines preferably comprise a C₆-C₂₀ linear or branched alkyl group. Suitable alkanolomines preferably comprise 1 to 12 carbon atoms, more preferably 6 to 9 carbon atoms. The alkanolamine may comprise more than one alkanol group, for example dialkanolamines and trialkanolamines. Preferred alkanolamines include monoethanolamine and triethanolamine. Other corrosion inhibitors include copper corrosion inhibitors such as benzotriazole, for example.

Suitably, the hydraulic fluid is substantially free of separate corrosion inhibitor. Suitably, the low levels of water, preferably the water free nature, of the hydraulic fluid may allow it to inhibit corrosion.

The hydraulic fluid may include a stabiliser. Many preferred embodiments of the hydraulic fluid of the invention do not require stabilisers, as they are stable in their own right. However certain additives and ingredients may be unstable in the hydraulic fluid for a variety of reasons. Suitable stabilisers include surfactants, which may effect increased solubility of ingredients in the hydraulic fluid. Suitable surfactants include ethoxylate surfactants. The hydraulic fluid may contain a biocidal additive. Biocidal additives useful in the hydraulic fluids of the invention, include sulphur-containing biocides and nitrogen-containing biocides. Suitable nitrogen-containing biocides include triazenes and guanidines.

The hydraulic fluid may comprise further additives such as a viscosity modifier. The viscosity modifier may be an agent capable of increasing the viscosity of the hydraulic fluid or, alternatively may be an agent capable of decreasing the viscosity. The type of viscosity modifier may depend on the application for which the fluid is used, the environmental conditions in which the fluid is used, and other factors. Suitable viscosity modifiers which increase the viscosity of the hydraulic fluid compared to when the modifier is not present, include long chain polymeric compounds such as high molecular weight ethylene oxide/propylene oxide copolymers and high molecular weight polyacrylic acid polymers. Suitable viscosity modifiers which serve to decrease the viscosity of the hydraulic fluid compared to when the modifier is not preset, include organic solvents such as ethylene glycol ethers and propylene glycol ethers.

The hydraulic fluids of the invention suitably contain less than 20% wt of a mineral oil, synthetic hydrocarbon oil, or any mixture thereof. Suitably, the hydraulic fluid comprises less than 1% by weight of a mineral oil, synthetic hydrocarbon oil or combination thereof. The hydraulic fluid may for example comprise no such oil.

In order to incorporate oleophilic lubricants into hydraulic fluids, it has been generally necessary to introduce mineral oils or synthetic hydrocarbon oils at a relatively high concentration. The inventors have surprisingly found that non-aqueous hydraulic fluids may be manufactured which utilise oleophilic phospholipids as a primary lubricant without the need to introduce large, small, or even trace quantities of oils, especially mineral or synthetic hydrocarbon oils.

The use of naturally occurring phospholipids, combined with utilisation of lower quantities of oils may further increases the beneficial environmental characteristics of the hydraulic fluids. The applicants have found that the non-aqueous hydraulic fluids of the invention may provide equivalent or superior torque reduction on rotating test members submerged in test fluids, as compared to commercially available oil-containing hydraulic fluids.

The hydraulic fluids of the invention are preferably substantially free from phosphorodithioates.

The composition of the hydraulic fluid, suitably the quantities of the phospholipid lubricant and a glycol, glycerol and/or a glycerol ester, may be varied to provide fluids of differing viscosity in line with a range of standard ISO hydraulic fluids. For example viscosities may be tailored to match Shell Tellus 46™ (46 cSt at 40° C.), Shell Tellus 22™ (22 cSt at 40° C.), Shell Tellus 68™ (68 cSt at 40° C.), synthetic oil based subsea control fluids such as Brayco Micronic HT200™ and other such products providing a range suitable for many individual hydraulic requirements.

The hydraulic fluids of the invention may be particularly suitable for use as hydraulic fluids in off-shore, mineral and mining industries.

Suitably, the hydraulic fluid is easily dispersible in water. The hydraulic fluid may suitably be easily dispersible in sea water in the event of a spillage to sea.

The hydraulic fluid may comprise any feature as described in relation to a proceeding aspect.

According to a second aspect of the present invention there is provided a hydraulic system comprising one or more hydraulically driven mechanical components and a hydraulic fluid according to the first aspect.

Examples of suitable hydraulic systems include: hydraulic systems on offshore oil and/or gas platforms and/or drilling units and/or vessels; hydraulic systems on ships and other sea going vessels; subsea hydraulic control systems; hydraulic systems on metal working machinery and/or hydraulic systems on vehicles and/or lifting equipment and/or earth moving equipment.

The hydraulic system may comprise any system capable of operating on standard hydraulic oils at temperatures below 100° C. Examples of specific applications may include: cranes, winches; BOP carriers; subsea control systems; closed loop BOP's; ships steering; gear systems; earth moving hydraulic applications such as diggers; and metal cutting tools.

The hydraulic system may comprise any or all hydraulic equipment types as identified in ISO 6743 under the title Lubricants, industrial oils and related products (class L)—Classification: encompassing Part 1: Family A (Total Loss Systems) to Part 99, general, with particular focus on Part 4 Family H (Hydraulic Systems):ISO 6743-4:1999. Suitable hydraulic systems may include systems that retain the hydraulic fluid during the lifetime of the hydraulic fluid and systems that consume the fluid in part or in whole.

The hydraulic system may comprise any feature as described in relation to the first aspect.

According to a third aspect of the present invention there is provided a method of using a hydraulic fluid according to the first aspect, said method comprising placing a supply of the hydraulic fluid into a fluid tank and pumping hydraulic fluid within a hydraulic system to operate one or more hydraulically driven mechanical components.

The method may comprise a method of operating a system according to the second aspect. The method may comprise any feature as described in relation to the first and/or second aspect.

According to a fourth aspect of the present invention there is provided a method of manufacturing a hydraulic fluid, wherein the method comprises blending a phospholipid lubricant and one or more of a glycol, glycerol or glycerol ester using a high pressure homogenisation process.

Suitably, the hydraulic fluid comprises a hydraulic fluid according to the first aspect.

Suitably, the high pressure homogenistation process employs a pressure of between 500PSI and 15,000PSI (35-1054 Kilograms/cm²)

Suitably, the homogenisation process employs a pressure of between 500PSI and 15,000PSI (35-1054 Kilograms/cm²) and the fluid undergoes at least one pass through a homogeniser during the manufacturing process. The fluid may undergo several passes through a homogeniser.

Suitably, the fluid components are passed through a high pressure homogeniser until a stable dispersion is achieved.

Suitably, by “stable dispersion” it is meant that the hydraulic fluid may be left to stand for a minimum of 3 months from manufacture, more suitably a minimum of 6 months from manufacture, substantially without the fluid separating into its component parts or forming precipitates or particulate matter.

Suitably, the dispersion comprises a dispersion of the phospholipid lubricant in a glycol, glycerol or glycerol ester or combination thereof.

Suitably, the high pressure homogenisation process is performed in industrial high pressure homogenisation equipment.

Suitably, following the high pressure homogenisation process the fluid composition is filtered to remove any large particles. Suitably, the filtering process comprises pumping the fluid through industrial filtration equipment capable of removing particles in excess of 2-5 micron where ISO 4406 14/11 (NAS 1638 Class 6) or better cleanliness is required. Suitably, the filtering process comprises pumping the fluid through industrial filtration equipment capable of removing particles in excess of 10-25 microns for other more general applications.

The method may comprise any feature as described in relation to the first aspect.

### DETAILED DESCRIPTION OF PREFERRED EMBODIMENTS

For a better understanding of the invention and to show how embodiments of the same may be put into effect, preferred embodiments of the invention will now be described by the following non-limiting examples:

### Example 1

A hydraulic fluid was prepared by mixing the ingredients of Table 1 then homogenising this mixture in a high pressure APV GAULIN homogeniser at pressures of 5,000 PSI (351 Kilograms/cm²) circulating the mixture through the high pressure unit for a total of 2 passes until a stable dispersion was achieved. The resultant fluid composition was then filtered thorough a PALL 10 micron absolute filtration unit to remove any large particles and provide a hydraulic fluid.

TABLE 1

| Component | Concentration (wt %) |
|---|---|
| Soybean lecithin (supplied by | 1 |
| Cargill PLC, UK) | |
| Monoethylene Glycol (supplied by | 49.5 |
| Univar PLC, UK) | |
| Glycerol (supplied by Univar PLC, | 49.5 |
| UK) | |

This hydraulic fluid, formulation A, was found to be suitable for use as a hydraulic oil in hydraulic systems traditionally designed to operate on standard ISO type hydraulic oils, in particular IS032 hydraulic oils such as Shell Tellus 32™.

### Example 2

A hydraulic fluid was prepared by mixing the ingredients of Table 2 then homogenising this mixture in a high pressure APV GAULIN homogeniser at pressures of 5,000 PSI (351 Kilograms/cm2), circulating the mixture through the high pressure unit for a total of 2 passes. until a stable dispersion was achieved. The resultant fluid composition was then filtered thorough a PALL 10 micron absolute filtration unit to remove any large particles and provide a hydraulic fluid.

TABLE 2

| Component | Concentration (wt %) |
|---|---|
| Soybean lecithin (supplied by | 1.5 |
| Cargill PLC, UK) | |
| Monoethylene Glycol (supplied by | 28.5 |
| Univar PLC, UK) | |
| Glycerol (supplied by Univar PLC, | 70.0 |
| UK) | |

This hydraulic fluid, formulation B, was found to be suitable for use as a hydraulic oil in hydraulic systems traditionally designed to operate on standard ISO type hydraulic oils, in particular TS046 hydraulic oils such as Shell Tellus 46™.

### Test Results

Lubricity tests were undertaken in accordance with ASTM D2670-95 (2004) as outlined in the test protocol described hereafter and the results are presented in Table 3 below.

TABLE 3

| FLUID | TORQUE @ 250 LB LOAD | WEAR TEETH |
|---|---|---|
| Formulation A | 10 LB. IN | 0 |
| SHELL TELLUS 32 | 14 LB. IN | 0 |
| Formulation B | 11 LB. IN | 0 |

It can be seen that the results for both formulation A and B compare favourably with those for the known ISO hydraulic oil Shell Tellus 32™.

### Test Protocols

A number of tests are referred to in this application and further details are given below.

### Lubricity Test

The lubricity of a hydraulic fluid may be measured according to the Falex Lubricity Test. This is detailed in ASTM D2670-95 (Reapproved 2004) but is briefly detailed herein for clarity.

The Falex tester measures the torque experienced on a rotating test pin submerged in the test fluid. The torque of the fluid is measured at 250 lb load and the wear recorded at this load after a duration of 15 minutes, with the level of wear on the test pin recorded in units of ‘wear teeth’.

### Viscosity Test

Viscosity may be measured according to IP 71 Section 1/97 Petroleum products—Transparent and opaque liquids—Determination of kinematic viscosity and calculation of dynamic viscosity. This is an IP-ASTM Joint Method, ASTM D 445-04e2 (Equivalent Standards are: BS 2000: Part 71: Section 1: 1996; EN ISO 3104: 1996; ISO 3104: 1994)

This test method specifies a procedure for the determination of the kinematic viscosity, ν, of liquid petroleum products, both transparent and opaque, by measuring the time for a volume of liquid to flow under gravity through a calibrated glass capillary viscometer (with the test carried out at a specified temperature, 40° C. being used herein, as is normal for ISO oils). The dynamic viscosity, η, can also be obtained by multiplying the kinematic viscosity, ν, by the density, p, of the liquid.

### Stability Test

Evidence of separation and precipitation may be monitored visually at various temperatures by maintaining a static environment for the fluid that involves absolute minimal fluid movement and monitoring the appearance of the fluid over time for signs of separation into layers, increasing haziness and/or precipitation. The fluid may for example be observed at ambient temperature for a specified test period, for example 3 months or more suitably 6 months. A fluid may be considered stable if substantially no signs as detailed above are observed.

In addition, at the end of a specified test period, for example 3 months or more suitably 6 months, the fluid may be filtered in line with methods outlined in ISO 5507:2002 ‘Determination of particulate contamination by the counting method using an optical microscope’ to ensure it does not exceed a code 22/20/17 (NAS 1638 Class 11) using ISO 4406:1999 test method ‘Fluids—methods for coding the levels of contamination by solid particles’ or similar.

It will be appreciated that properties of a suitable fluid may be assessed by other suitable tests and the above test protocols are provided simply as examples of tests which may be applied.

It will be appreciated that preferred embodiments of hydraulic fluids of the present invention may suitably be substantially non-aqueous but may be able to withstand a certain tolerance of water below 10% without system corrosion, instability and emulsion formation issues.

Previously it had been believed that a composition comprising plant derived lecithin, monoethylene glycol and glycerol, or more generally at least one phospholipid lubricant blended with one or more of a glycol, glycerol or a glycerol ester, was required to be a water based emulsion. Surprisingly, this has been found not to be the case. Preferred embodiments of hydraulic fluids as described herein may have good product stability and the required technical performance without the inclusion of water. A stable fluid may be produced without the need to form an oil in water emulsion. That this may be achieved using high pressure homogenisation without using water as a stabilising medium is surprising.

The use of low levels of water, or preferably no water, in preferred embodiments of hydraulic fluids may be beneficial. For example changing out hydraulic systems to introduce preferred embodiments of hydraulic fluids as described herein may be more convenient than introducing a water based fluid. If a water based fluid was used any residual oil based product remaining after flushing operations would have the potential to emulsify with the water in the replacement fluid. This is a previously unrecognised problem noted by the present inventors. It has now been found that having less than 10%, preferably less that 5%, preferably no water, may significantly decrease or eliminate the likelihood of emulsion formation when systems are changed. Emulsion formation can cause extreme problems such as blocked filters, ‘creamy residue build up’ and subsequent system failure. Having less than 10% and preferably no water may help eliminate such potential contamination issues when flushing and re-filling hydraulic fluids previously using oil based products.

The use of less than 10%, preferably less than 5%, preferably no water in preferred embodiments of hydraulic fluids as described herein may eliminate the need for additional corrosion inhibitors to protect hydraulic systems from corrosion in service. This may be particularly so for preferred formulations containing lecithin, glycerol and glycol. Reducing the need for additional corrosion inhibitors may improve the environmental acceptability of the fluid and may eliminate the need for extensive additional testing to ensure that added corrosion inhibitors are stable within the fluid formulation and functioning correctly.

It will be appreciated that preferred embodiments of the present invention may provide satisfactory hydraulic fluids. Such fluids may meet or exceed the technical performance properties of standard ISO hydraulic oils, particularly in terms of lubricity, anti-wear and product stability but also in terms of corrosion protection, material compatibility (both metallic and elastomeric), bacterial and fungal protection.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments). The invention extends to any novel one, or any novel combination, of the features disclosed in this specification (including any accompanying claims, abstract and drawings), or to any novel one, or any novel combination, of the steps of any method or process so disclosed.

1. A hydraulic fluid comprising at least one phospholipid lubricant blended with one or more of a glycol, glycerol or a glycerol ester and having a water content of less than 10% by weight.

2. A hydraulic fluid according to claim 1, wherein the hydraulic fluid comprises a stable fluid and wherein the stability of the fluid is achieved by a high pressure homogenisation process during manufacture.

3. A hydraulic fluid according to claim 1, wherein the hydraulic fluid has a viscosity of between 10 cSt and 200 cSt at 40° C.

4. A hydraulic fluid according to claim 1, wherein the hydraulic fluid is capable of operation at temperatures below −10° C.

5. A hydraulic fluid according to claim 1, wherein the hydraulic fluid is sufficiently environmentally acceptable to allow its discharge to the environment.

6. A hydraulic fluid according to claim 1, wherein the hydraulic fluid has a water content of 1% or less.

7. A hydraulic fluid according to claim 1, wherein they hydraulic fluid has a water content of 0.1% or less.

8. A hydraulic fluid according to claim 1, wherein the hydraulic fluid comprises a blend of a phospholipid lubricant and one or more of a glycol, glycerol or a glycerol ester in which said blend forms at least 60% by weight of the fluid.

9. A hydraulic fluid according to claim 1, wherein the hydraulic fluid comprises a blend of phospholipid lubricant and one or more of a glycol, glycerol or a glycerol ester in which said blend forms 85% by weight or greater of the fluid.

10. A hydraulic fluid according to claim 1, wherein the hydraulic fluid consists essentially of blend of a phospholipid lubricant and one or more of a glycol, glycerol or a glycerol ester.

11. A hydraulic fluid according to claim 1, wherein the hydraulic fluid is substantially free of a mineral oil, a synthetic hydrocarbon oil or any mixture thereof.

12. A hydraulic fluid according to claim 1, wherein the hydraulic fluid comprises the phospholipid as substantially the sole lubricant of the hydraulic fluid.

13. A hydraulic fluid according to claim 1, wherein from 0.1% to 50% by weight of the fluid consists of phospholipid.

14. A hydraulic fluid according to claim 1, wherein the phospholipid lubricant comprises a phosphatide, especially having a structure 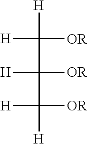
wherein at least one R is a phosphorus containing group having the structure 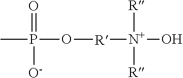
and at least one R is a fatty acyl group; and
wherein R′ is independently an alkyl group preferably independently having from 1 to 12 carbon atoms and R″ is an alkyl group preferably independently having from 1 to 8 carbon atoms, more preferably from 1 to 4 carbon atoms.

15. A hydraulic fluid according to claim 1, wherein the hydraulic fluid comprises a plant-derived lecithin.

16. A hydraulic fluid according to claim 1, wherein the total weight of a glycol, glycerol, a glycerol ester or combination thereof is substantially 30 to 99.9% wt of the total weight of the hydraulic fluid.

17. A hydraulic fluid according to claim 1, wherein the hydraulic fluid comprises a combination of only two of a glycol, glycerol or a glycerol ester.

18. A hydraulic fluid according to claim 1, wherein the hydraulic fluid comprises a combination of a glycol and glycerol.

19. A hydraulic fluid according to claim 1, wherein the hydraulic fluid comprises plant derived lecithin, monoethylene glycol and glycerol and wherein the plant derived lecithin, monoethylene glycol and glycerol comprise at least 90% by weight of the fluid.

20. A hydraulic fluid according to claim 1, wherein the hydraulic fluid is arranged to be used in hydraulic machinery as supplied.

21. A hydraulic system comprising one or more hydraulically driven mechanical components and a hydraulic fluid according to claim 1.

22. A system according to claim 21, wherein the system comprises one of: hydraulic systems on offshore oil and/or gas platforms and/or drilling units and/or vessels; hydraulic systems on ships and other sea going vessels; subsea hydraulic control systems; hydraulic systems on metal working machinery and/or hydraulic systems on vehicles and/or lifting equipment and/or earth moving equipment.

23. A method of using a hydraulic fluid according to claim 1, said method comprising placing a supply of the hydraulic fluid into a fluid tank and pumping hydraulic fluid within a hydraulic system to operate one or more hydraulically driven mechanical components.

24. A method according to claim 23, wherein the method comprises a method of operating a system according to claim 21.

25. A method of manufacturing a hydraulic fluid, wherein the method comprises blending a phospholipid lubricant and one or more of a glycol, glycerol or glycerol ester using a high pressure homogenisation process.

26. A method according to claim 25, wherein the hydraulic fluid comprises a hydraulic fluid according to claim 1.
